(19) United States
(12) Patent Application Publication
(10) Pub. No.: US 2008/0296342 A1
(43) Pub. Date: Dec. 4, 2008

(54) Nail Gun for Rapidly Detaching Magazine Assembly

(76) Inventor: Chi-Sheng Huang, Taipei Hsien (TW)

Correspondence Address: HDSL, P.O. BOX 220746, CHANTILLY, VA, 20153-0746, US

(21) Appl. No.: 11/755,092

(22) Filed: May 30, 2007

(51) Int. Cl. B27F 7/13

(52) U.S. Cl. 227/120

(57) ABSTRACT

A nail gun includes a handle, a magazine assembly, and a fastener. The handle includes a pin joint base for receiving a position pin, with a head portion. One end of the magazine assembly couples with a gun body of the nail gun. The magazine assembly includes a coupling base, which includes a slotted pin aperture. The slotted pin aperture has an end portion and a slotted block portion intercommunicated with each other, the head portion of the position pin passing through the end portion and being embedded at the slotted block portion. The fastener is disposed between the magazine assembly and the coupling base, which has an external stopper and an inner stopper. The fastener can swing to the slotted block portion, which drives the external and the inner stoppers to block the head portion of the position pin, and drives the external stopper to be disposed between the end portion and the slotted block portion.

### BACKGROUND

The present invention relates to a nail gun for rapidly detaching magazine assembly from a gun body thereof, and particularly to a configuration of a nail gun, which can firmly load magazine assembly thereon and easily and rapidly detach magazine assembly therefrom.

Conventional magazine assembly is screwed on a handle of a nail gun, and a top portion of the magazine assembly inserts into a gun body of the nail gun. The magazine assembly holds a plurality of fasteners, such as staples and nails, and feeds the fasteners into a hitting nose in the gun body of the nail gun, which the fasteners are driven into workpieces. However, when one or more fasteners are jammed in the hitting nose of the nail gun, the magazine assembly is typically needed to be removed from the nail gun to provide sufficient space to permit the operator to remove the jammed fasteners from the hitting nose of the nail gun. In such situations, the removal of the magazine assembly from the nail gun is often time consuming and may also require the use of additional tools to physically detach the magazine assembly.

For resolve the above described questions, a technology for rapidly detaching the magazine assembly from a nail gun has been developed, as shown in U.S. Pat. No. 6,938,812. A fastening tool is disclosed. The fastening tool has a clamp boss at its handle portion. The clamp boss has a clamp pin loaded with an elastic distortion pressure, and a U-shaped body portion formed at a magazine assembly. The U-shaped body portion includes a slotted pin aperture that includes a circular portion, a slotted portion connected with the circular portion. The circular portion is sized to receive a head portion of the clamp pin, and the slotted portion is sized to slidingly receive a first body section of the clamp pin. The head portion of the clamp pin is pushed to an end portion of the slotted portion through a driving force of the elastic distortion pressure. Thus, the magazine assembly can be coupled to the fastening tool, or be detached from the fastening tool when a negative direction force is provided to the clamp pin.

However, the fastening tool does not close the slotted portion of the U-shaped body portion, which makes the clamp pin easily sliding toward the circular portion. Thus, the coupling characteristics between the magazine assembly and the fastening tool are not firmly. The clamp pin easily works loss and the magazine assembly easily falls off from the fastening tool.

### BRIEF SUMMARY

An exemplary nail gun includes a handle, a magazine assembly, and a fastener. The handle includes a pin joint base for receiving a position pin, which the position pin includes a head portion and is nested with a spring for driving the head portion engaging with the pin joint base. One end of the magazine assembly couples with a gun body of the nail gun. The magazine assembly includes a coupling base, which includes a slotted pin aperture. The slotted pin aperture has an end portion and a slotted block portion intercommunicated with each other, the head portion of the position pin passing through the end portion and being embedded at the slotted block portion. The fastener is disposed between the magazine assembly and the coupling base, which has an external stopper and an inner stopper. The fastener can swing to the slotted block portion, which drives the external and the inner stoppers to block the head portion of the position pin, and drives the external stopper to be disposed between the end portion and the slotted block portion.

In the nail gun, the external and the inner stoppers of the fastener cooperate to block the head portion of the position pin. In addition, the external stopper is disposed between the end portion and the slotted block portion, which closes the slotted block portion and blocks the head portion in the slotted block portion. Thus, the fastener can assure a firmly joint of the magazine assembly and the handle of the nail gun.

In an alternative embodiment, the external and inner stoppers of the fastener each has a front slant guiding face and a rear slant guiding face, and a ridged guiding surface connecting the front slant guiding face and the rear slant guiding face. The head portion can slide along the front slant guiding faces and the two ridged guiding surfaces of the fastener into the two rear slant guiding faces for blocking the head portion of the position pin. The two rear slant guiding faces define an arc-shaped abutting surface, which engage with the head portion.

In another alternative embodiment, the fastener further comprises a toggle portion to enable the fastener swing.

In a further another alternative embodiment, the fastener further comprises a pin hole for pin jointing the magazine assembly and the coupling base, whose center position can be changed according to the actual needs.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 is a schematic, exploded, perspective view of a nail gun according to a preferred embodiment of the present invention, which has a gun body, a handle, a magazine assembly and a fastener;

FIG. 2 is an assembly view of the nail gun of FIG. 1;

FIG. 2a is a crossed-sectional view of a part of FIG. 2 taken along a line of 2a-2a;

FIG. 3 is a partially enlarged view of the nail gun of FIG. 2;

FIG. 3a is a crossed-sectional view of a part of FIG. 3 taken along a line of 3a-3a;

FIG. 3b is a partially enlarged view of the nail gun of FIG. 3;

FIG. 4 is a front view of the fastener of FIG. 1;

FIG. 5 is a schematic, perspective view of the fastener of FIG. 4;

FIG. 6 is a plane view of the nail gun showing an operation state of assembling the magazine assembly to the gun body;

FIG. 7 is a cross-sectional view of a part of the FIG. 6;

FIG. 8 is a partially plane view of the nail gun showing an another operation state of coupling the magazine into the gun body;

FIG. 9 is a cross-sectional view of the part of the nail gun of FIG. 8;

FIG. 10 is a partially plane view of the nail gun showing a further another operation state of pushing the fastener;

FIG. 11 is a cross-sectional view of the part of the nail gun of FIG. 10;

FIG. 12 is a partially plane view of the nail gun showing a further another operation state of further pushing the fastener;

FIG. 13 is a cross-sectional view of the part of the nail gun of FIG. 12;

FIG. 14 is a partially plane view of the nail gun showing a further another operation state of positioning the magazine assembly at the handle; and

FIG. 15 is a cross-sectional view of the part of the nail gun of FIG. 14.

### DETAILED DESCRIPTION

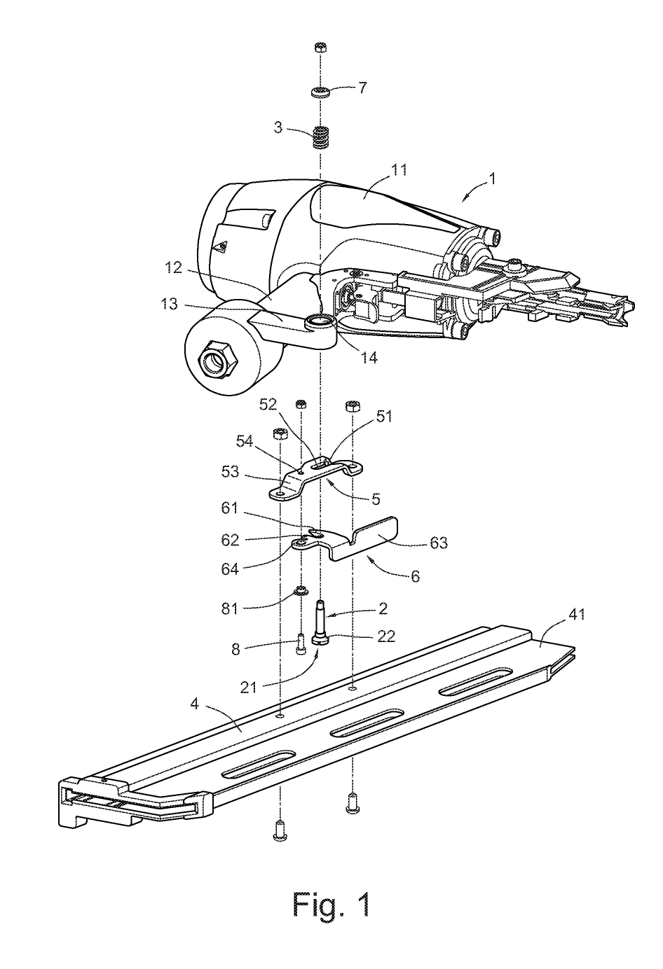

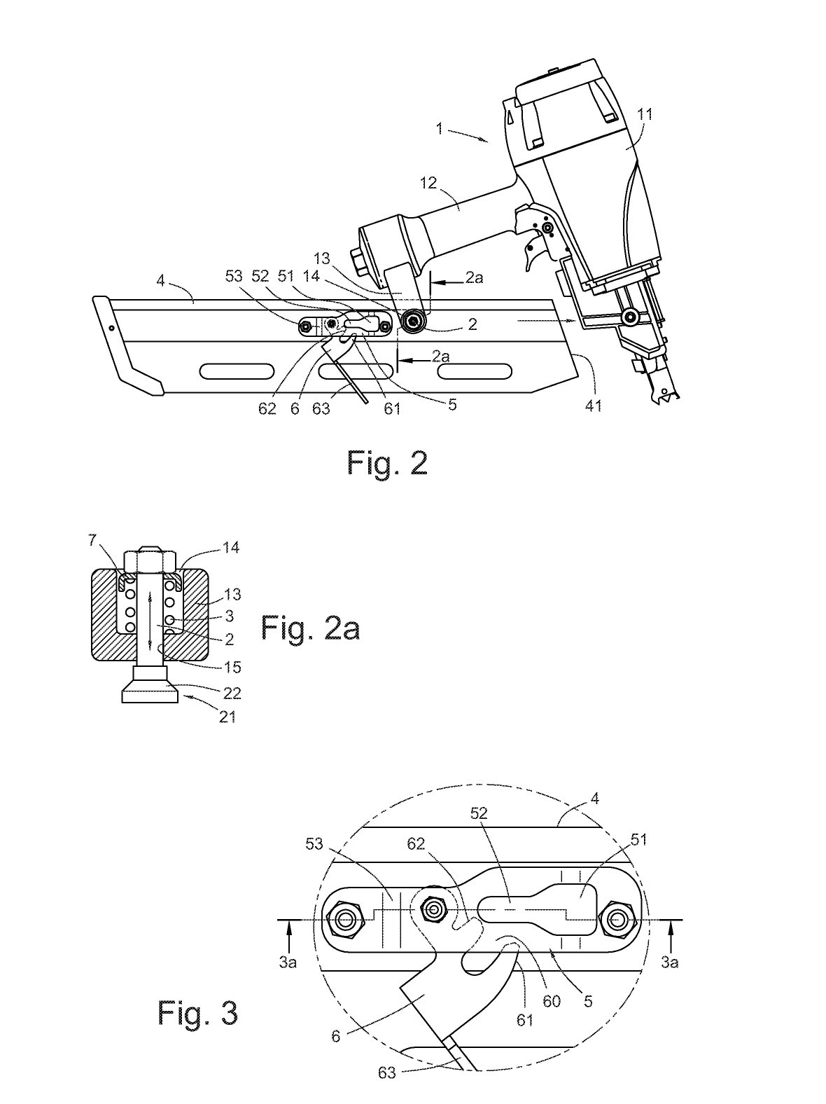

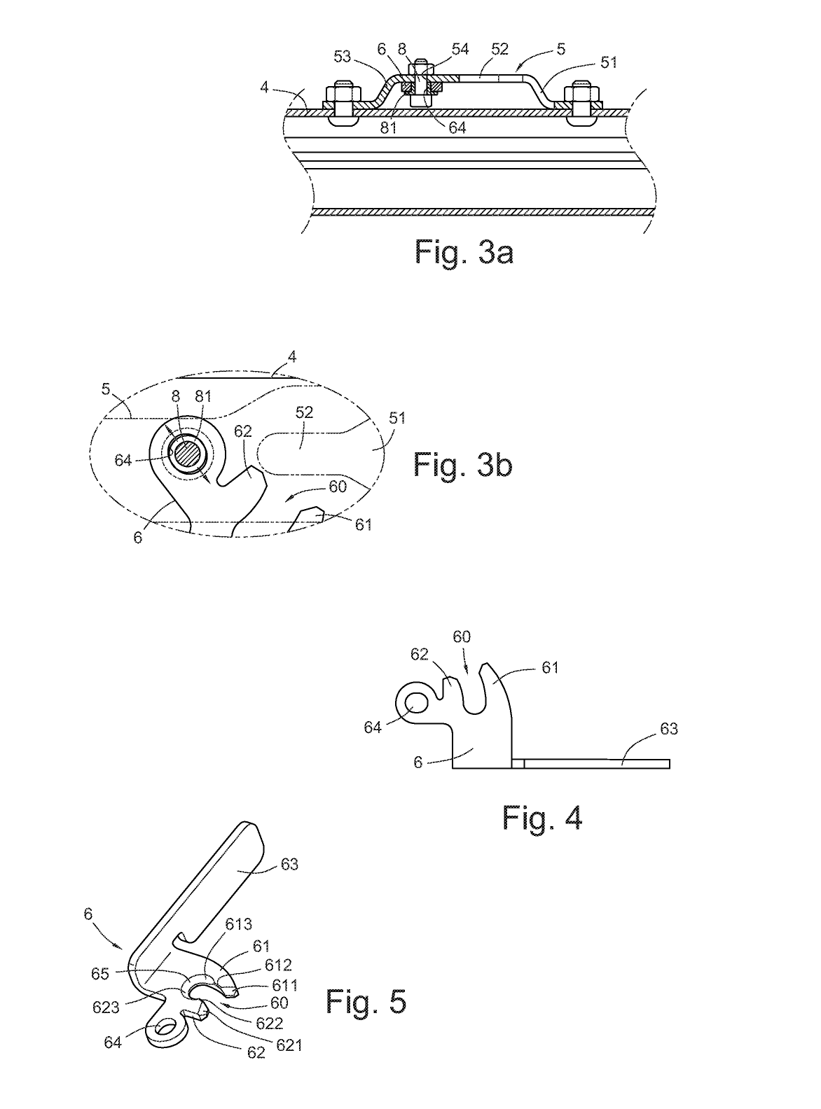

As shown in FIG. 1 and FIG. 2, a nail gun 1 according to a preferred embodiment of the present invention is shown. The nail gun 1 has a handle 12 which includes a pin joint base 13. The pin joint base 13 has a pin aperture 14 for receiving a position pin 2 (as shown in FIG. 2a). The position pin 2 has a frusto-conical head portion 21 and a body section (not labeled). The frusto-conical head portion 21 has a frusto-conical abutting surface 22. A spring 3 is provided and winds around the body section of the position pin 2, which is used to drive the head portion 21 of the position pin 2 to touch the pin joint base 13. The nail gun 1 further has a gun body 11, which joints with a top portion 41 of a magazine assembly 4. The magazine assembly 4 has a coupling base 5 (as shown in FIG. 3 and FIG. 3a) formed thereon. The coupling base 5 has a slotted pin aperture (not labeled) that includes an end portion 51 and a slotted block portion 52 having a width that is smaller than that of the end portion 51 and which interconnects with the end portion 51. The end portion 51 is sized to receive the head portion 21 of the position pin 2, and the slotted block portion is sized to slidingly receive the body section of the position pin 2. Thus, the position pin 2 is positioned at the magazine assembly 4 through the head portion 21 passing through the end portion 51 of the coupling base 5 and the body section of the position pin 2 sliding into the slotted block portion 52 to embed the head portion 21 thereat (as shown in FIGS. 7 and 9). A fastener 6 is provided between the coupling base 5 and the magazine assembly 4, which includes an external stopper 61 and an inner stopper 62 (as shown in FIGS. 4 and 5).

In detail, the pin aperture 14 has a neck portion 15 (as shown in FIG. 2a) formed at one end, the position pin 2 is screwed with a ring plate 7, and the spring 3 is nested between the neck portion 15 and the ring plate 7, which makes the head portion 21 of the position pin 2 can be pushed toward a direction far away the neck portion 15 under a force, and can be reposited when the force is released. The coupling base 5 is screwed on the magazine assembly 4 through two end legs 53, each leg 53 coupling a side of the coupling base 5 (as shown in FIGS. 1, 2 and 3a). Thus, the coupling base 5 having the end portion 51 and the slotted block portion 52 are hanged on the magazine assembly 4. In addition, an axle hole 54 is provided on the coupling base 5.

The fastener 6 has a pin hole 64, whose center position can be changed according to the actual needs (as shown in FIGS. 1, 3a, 3b, 4 and 5). The pin hole 64 receives a circular spindle sleeve 81. A circular shaft 8 is provided, which passes through the circular spindle sleeve 81 and the axle hole 54 for making the fastener 6 to produce a minim radial displacement in a swing range. The fastener 6 further has a toggle portion 63, which is used to drive the fastener 6 to oscillating traverse.

The external and inner stoppers 61, 62 of the fastener 6 each has a front slant guiding face 611, 621 and a rear slant guiding face 613, 623 (as shown in FIG. 5). Two ridged guiding surfaces 612, 622 are respectively disposed between the front slant guiding faces 611, 621 and the rear slant guiding faces 613, 623, which connect the front slant guiding faces 611, 621 and the rear slant guiding faces 613, 623, respectively. An entrance 60 is defined between the two front slant guiding faces 611, 621 (as shown in FIGS. 3, 3b, and 4). An arc-shaped abutting surface 65 is defined by the two rear slant guiding faces 613, 623, which is configured to confront the frusto-conical abutting surface 22 of the position pin 2 for adding the touch area of the position pin 2 and the fastener 6.

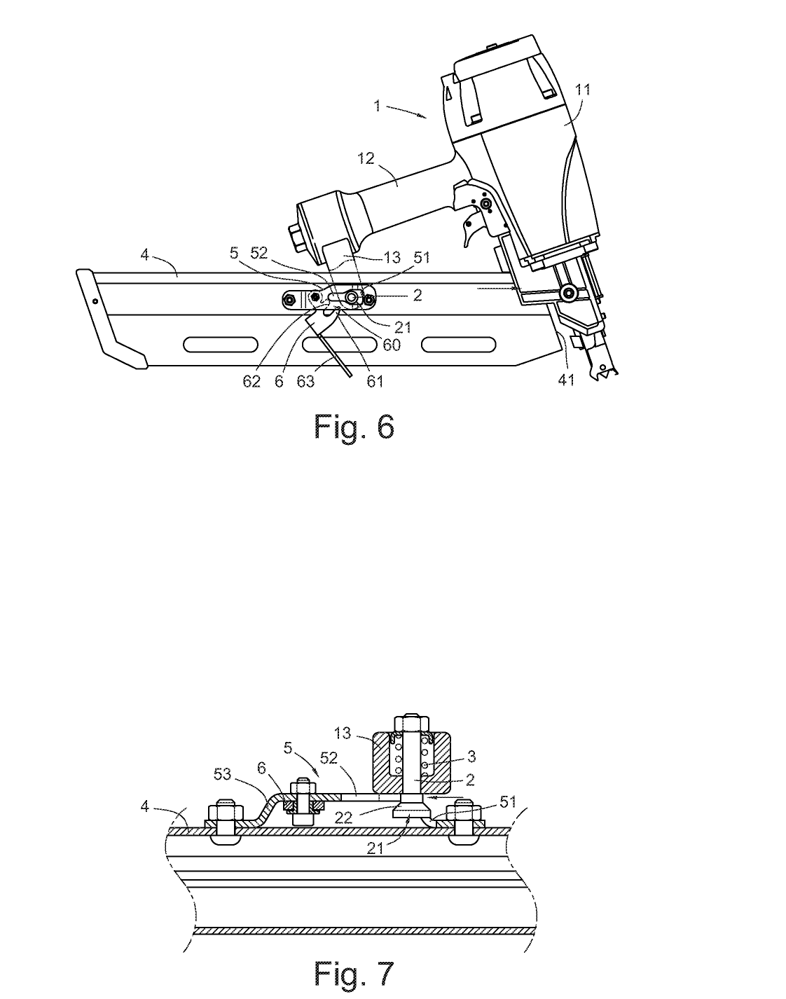

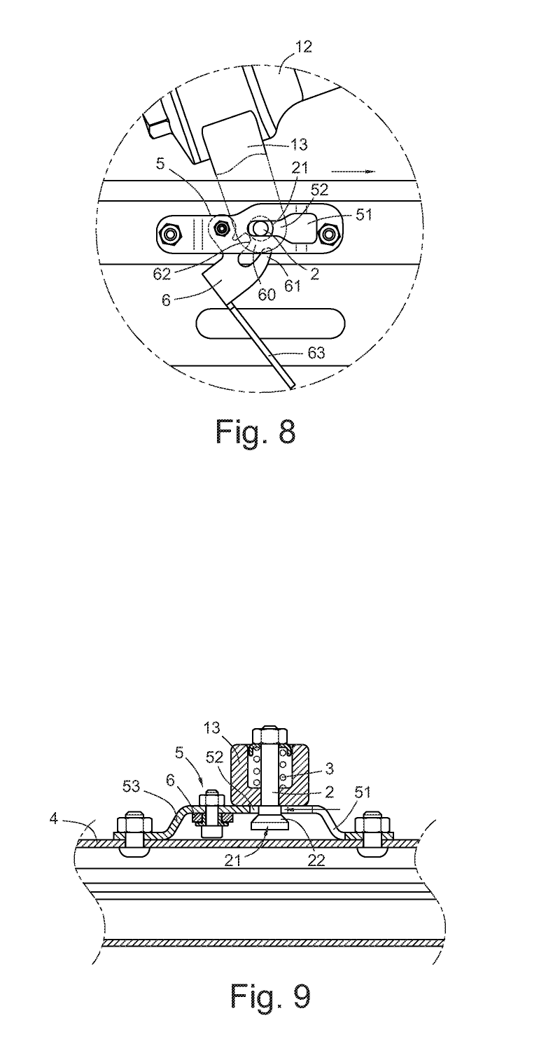

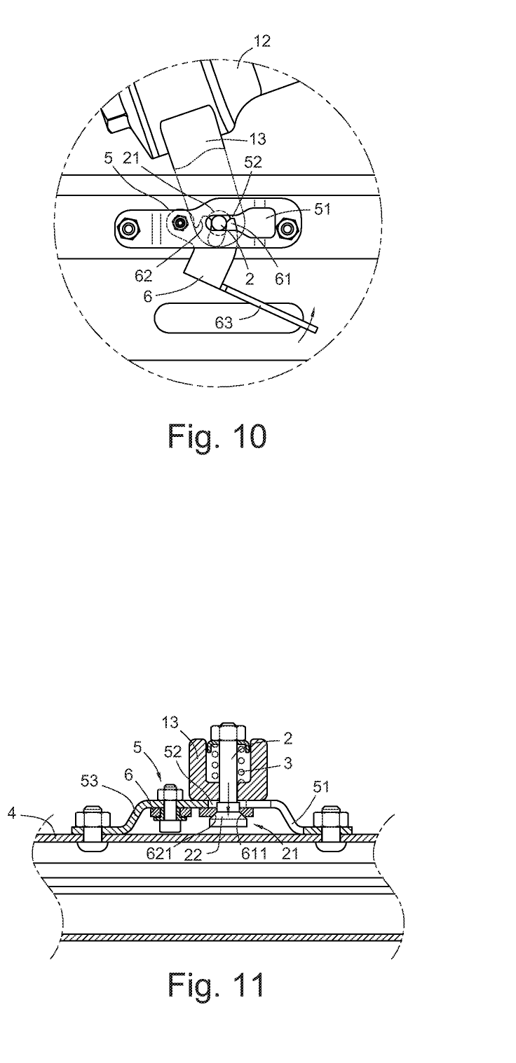

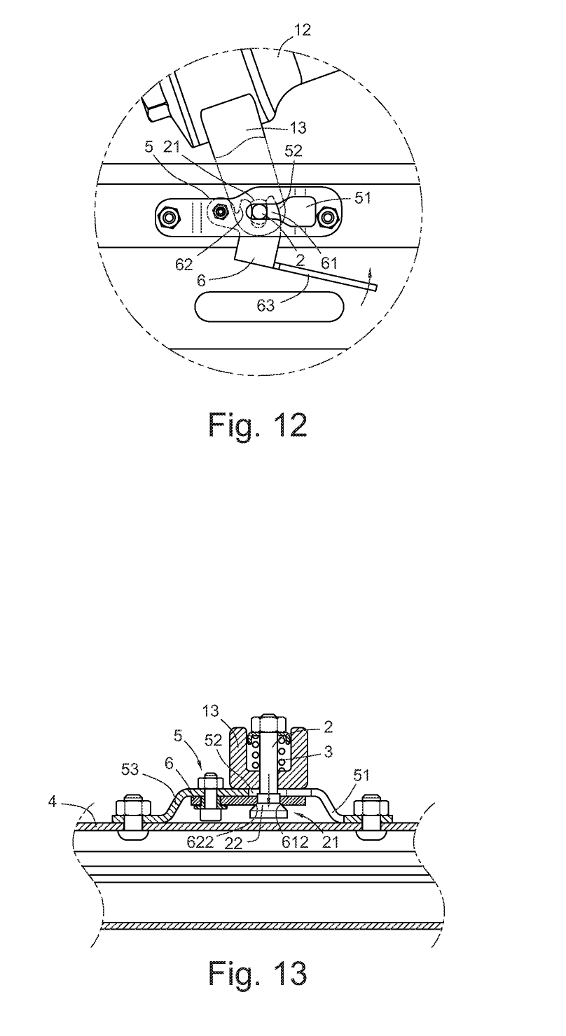

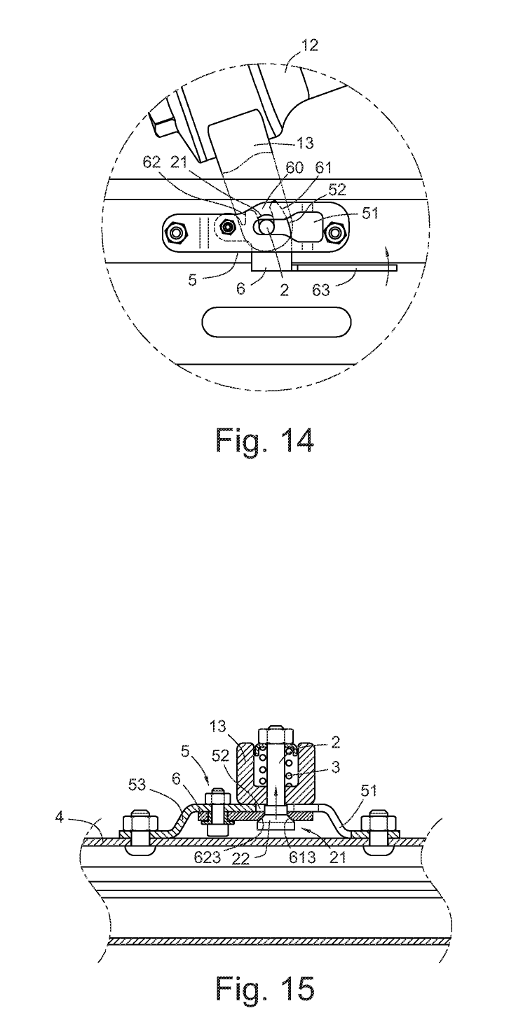

In operation, when an operator assembles the magazine assembly 4 on the nail gun 1, firstly, the top portion 41 of the magazine assembly 4 is inserted into the gun body 11 of the nail gun 1 (as shown in FIGS. 2 and 6); at the same time, the head portion 21 of the position pin 2 passes through the end portion 51 of the coupling base 5 and is embedded at the slotted block portion 52 after the body section of the position pin 2 slides to a tail end of the slotted pin aperture, opposite to the end portion 51 (as shown in FIGS. 7 to 9), and then the operator can dial the toggle portion 63 of the fastener 6 to drive the fastener 6 to move toward the tail end of the slotted block portion 52 (as shown in FIGS. 10 and 11) and drive the fastener 6 to produce a minim radial displacement for adjusting the entrance 60 of the fastener 6 aligning with the head portion 21 of the position pin 2. After that, the operator can continue to push the toggle portion 63 to feed the head portion 21 into the entrance 60, such that the front slant guiding faces 611, 621 of the external and the inner stoppers 61, 62 are inserted between the head portion 21 and the slotted block portion 52, and the front slant guiding faces 611, 621 push the head portion 21 and drive the position pin 2 to move toward a direction far away the neck portion 15 (as shown in FIGS. 12, 13). Finally, the operator continues to push the toggle portion 63, the head portion 21 slides along the two ridged guiding surfaces 612, 622 of the fastener 6 into the two rear slant guiding faces 613, 623 (as shown in FIGS. 14 and 15). Thus, the frusto-conical abutting surface 22 of the head portion 21 engages with the arc-shaped abutting surface 65 that is formed at the connecting end of the external and the inner stopper 61, 62 to both locate the magazine assembly 4 relative the gun body 11 as well as mechanically lock the position pin 2, i.e. the two ridged guiding surfaces 612, 622 of the fastener 6 can limit the head portion 21 of the position pin 2 sliding from the two rear slant guiding faces 613, 623 to the front slant guiding faces 611, 621. That is, the external and the inner stoppers 61, 62 of the fastener 6 cooperate to block the head portion 21 of the position pin 2. In addition, the external stopper 61 is disposed between the end portion 51 and the slotted block portion 52, which closes the slotted block portion 52 and blocks the head portion 21 in the slotted block portion 52. Thus, the fastener 6 can assure a firmly joint of the magazine assembly 4 and the handle 12 of the nail gun 1.

When the operator needs to disassemble the magazine assembly 4 from the nail gun 1, the operator just need to dial the toggle portion 63 of the fastener 6 for driving it to move along a counter direction and leave the slotted block portion 52. The external and the inner stoppers 61, 62 of the fastener 6 release the head portion 21 of the position pin 2, and the external stopper 61 leaves the position between the end portion 51 and the slotted block portion 52. That is, the external stopper 61 opens the slotted block portion 52. Thus, the head portion 21 of the position pin 2 can slide out. After that, the top portion 41 of the magazine assembly 4 can be taken out from the gun body 11. Therefore, the magazine assembly 4 can be rapidly and easily detached down from the nail gun 1, which makes the assembly and disassembly of the nail gun 1 conveniently.

The above description is given by way of example, and not limitation. Given the above disclosure, one skilled in the art could devise variations that are within the scope and spirit of the invention disclosed herein, including configurations ways of the recessed portions and materials and/or designs of the attaching structures. Further, the various features of the embodiments disclosed herein can be used alone, or in varying combinations with each other and are not intended to be limited to the specific combination described herein. Thus, the scope of the claims is not to be limited by the illustrated embodiments.

1. A nail gun comprising:
a handle, which comprises a pin joint base for receiving a position pin, the position pin comprising a head portion and being nested with a spring for driving the head portion engaged with the pin joint base;
a magazine assembly comprising a coupling base with an axle hole, one end of the magazine assembly coupling with a gun body of the nail gun, the coupling base comprising a slotted pin aperture which comprises an end portion and a slotted block portion intercommunicated with each other, the head portion of the position pin passing through the end portion and being embedded at the slotted block portion; and
a fastener disposed between the magazine assembly and the coupling base, which comprises an external stopper and an inner stopper,
wherein the fastener can swing to a tail end of the slotted block portion, which drives the external and the inner stoppers to block the head portion of the position pin, and drives the external stopper to be disposed between the end portion and the slotted block portion, and
wherein the fastener has a pin hole whose center position can be changed, the pin hole receives a circular spindle sleeve, and a circular shaft is provided to pass through the circular spindle sleeve and the axle hole for making the fastener to produce a minim radial displacement in a swing range for adjusting entrance of the fastener aligning with the head portion of the position pin.

2. The nail gun as claimed in claim 1, wherein the external and the inner stoppers of the fastener each comprises a front slant guiding face and a rear slant guiding face, and a ridged guiding surface connecting the front slant guiding face and the rear slant guiding face.

3. The nail gun as claimed in claim 2, wherein the two rear slant guiding faces define an arc-shaped abutting surface.

4. The nail gun as claimed in claim 1, wherein the head portion is frusto-conical shaped, and comprises a frusto-conical abutting surface.

5. The nail gun as claimed in claim 1, wherein the fastener further comprises a toggle portion to enable the fastener swing.

6. (canceled)
